(19) United States
(12) Patent Application Publication
(10) Pub. No.: US 2014/0117152 A1
(43) Pub. Date: May 1, 2014

(54) Twin Tip Turbine Propulsors Powered by a Single Gas Turbine Generator

(71) Applicant: UNITED TECHNOLOGIES CORPORATION, Hartford, CT (US)

(72) Inventors: Gabriel L. Suciu, Glastonbury, CT (US); Jesse M. Chandler, South Windsor, CT (US); Joseph B. Staubach, Colchester, CT (US); Adam Joseph Suydam, Ocala, FL (US)

(73) Assignee: United Technologies Corporation, Hartford, CT (US)

(21) Appl. No.: 13/662,879

(22) Filed: Oct. 29, 2012

(51) Int. Cl. B64D 27/14; F02K 3/02

(52) U.S. Cl. CPC B64D 27/14; F02K 3/025
USPC 244/54; 60/226.1

(57) ABSTRACT

A gas turbine engine has a core engine incorporating a turbine, and a manifold positioned downstream of the turbine. The manifold delivers gas downstream of the turbine into at least two nacelles, with each of the nacelles receiving a fan rotor. The fan rotor is fixed to rotate with a tip turbine mounted at a radially outer location of the fan rotor, with the tip turbine being in the path of gases from the manifold. An aircraft is also disclosed.

### STATEMENT REGARDING FEDERALLY SPONSORED RESEARCH OR DEVELOPMENT

This invention was made with government support under NASA Cooperative Agreement No. NNX11AB35A. The Government has certain rights in this invention.

### BACKGROUND OF THE INVENTION

This application relates to an arrangement where a single gas turbine engine gas generator powers at least two propulsors.

Gas turbine engines are known, and have typically included a fan delivering air into both a bypass duct as propulsion, and into a core engine. The air leading into the core engine is compressed in a compressor section, mixed with fuel in a combustor section, and ignited. Products of this combustion pass downstream over turbine rotors, driving them to rotate. The turbine rotors in turn mechanically drive the fan and compressor.

While this basic arrangement has proven successful, future aircraft designs require more flexibility.

### SUMMARY OF THE INVENTION

In a featured embodiment, a gas turbine engine has a core engine incorporating a compressor, a combustor and a turbine. A manifold is positioned downstream of the core engine turbine, and delivers gas downstream into at least two nacelles. Each of the nacelles receive a propulsor fan rotor. Each fan rotor is fixed to rotate with a tip turbine mounted at a radially outer location of the propulsor fan rotor. Each tip turbine is in the path of gases from the manifold.

In another embodiment according to the previous embodiment, the core engine extends in a forward direction from the propulsor fan rotors.

In another embodiment according to any of the previous embodiments, the core engine incorporates a core fan rotor.

In another embodiment according to any of the previous embodiments, the propulsor fan rotors drive air through their respective nacelles as propulsion air.

In another embodiment according to any of the previous embodiments, the gases passing over the tip turbines pass into the nacelle, and mix with air driven by the propulsor fan rotors.

In another embodiment according to any of the previous embodiments, each of the propulsor fan rotors has a shaft mounted within a bearing. The bearing is fixed to the nacelle.

In another embodiment according to any of the previous embodiments, a plurality of static vanes are positioned downstream relative to the fan rotor.

In another embodiment according to any of the previous embodiments, the static vanes are fixed to the bearing.

In another embodiment according to any of the previous embodiments, each propulsor fan rotor and core engine turbine rotate about an axis, and the axes of rotation of the core engine turbine. Each of the fan rotors are offset relative to each other.

In another featured embodiment, an aircraft has an aircraft body including a tail section, with a gas turbine engine mounted on the tail section. The turbine engine includes a core engine incorporating a compressor, a combustor and a turbine. A manifold is positioned downstream of the core engine turbine and delivers gas downstream of the engine turbine into at least two nacelles. Each of the nacelles receive a propulsor fan rotor. Each fan rotor is fixed to rotate with a tip turbine mounted at a radially outer location of the propulsor fan rotor, with each tip turbine being in the path of gases from the manifold.

In another embodiment according to the previous embodiment, the core engine extends in a forward direction from the propulsor fan rotors.

In another embodiment according to the previous embodiment, the core engine incorporates a core fan rotor.

In another embodiment according to the previous embodiment, the propulsor fan rotors drive air through their respective nacelles as propulsion air.

In another embodiment according to the previous embodiment, the gases passing over the tip turbines pass into the nacelle, and mix with the air driven by the propulsor fan rotors.

In another embodiment according to the previous embodiment, each of the propulsor fan rotors has a shaft mounted within a bearing. The bearing is fixed to the nacelle.

In another embodiment according to the previous embodiment, a plurality of static vanes are positioned downstream relative to the fan rotor.

In another embodiment according to the previous embodiment, the static vanes are fixed to the bearing.

In another embodiment according to any of the previous embodiments, each propulsor fan rotor and core engine turbine rotate about an axis, and the axes of rotation of the core engine turbine. Each of the fan rotors are offset relative to each other.

In another featured embodiment, a gas turbine engine has a core engine incorporating a core engine turbine rotating about an axis. A manifold is positioned downstream of the core engine turbine, and delivers gas downstream of the core engine turbine into at least two nacelles. Each nacelle receives a propulsor fan rotor. Each propulsor fan rotor is fixed to rotate with a fan rotor turbine. The fan rotor turbines are in the path of gas from the manifold. The axes of rotation of the core engine turbine, and the propulsor fan rotors are offset relative to each other.

In another embodiment according to the previous embodiment, the fan rotor turbines are tip turbines mounted at a radially outer location of each propulsor fan rotor.

These and other features of this application will be best understood from the following specification and drawings, the following of which is a brief description.

### BRIEF DESCRIPTION OF THE DRAWINGS

FIG. 1 shows an aircraft.

FIG. 2 shows an arrangement of a gas turbine engine for the FIG. 1 aircraft.

FIG. 3 is an exploded view of a portion of the FIG. 2 engine.

FIG. 4 shows further detail.

### DETAILED DESCRIPTION

An aircraft 20 has a tail area 126 provided with a pair of twin propulsor units 22 and 24. The propulsor units include a fan rotor that will drive a large volume of air to provide propulsion for the aircraft. A single gas turbine core engine, or gas generator 26 will drive both propulsor units 22 and 24, as explained below.

As shown in FIG. 2, the gas generator 26 includes a frame 127 at a forward end mounting rotating parts of the engine. Although shown schematically, a compressor section 128, a combustor section 130, and a turbine section 132 are all included in the core engine 26. Air passes into the compressor section 128, the combustor section 130, and into the turbine section 132. The turbine section 132 drives compressor rotors (not shown) within compressor section 128.

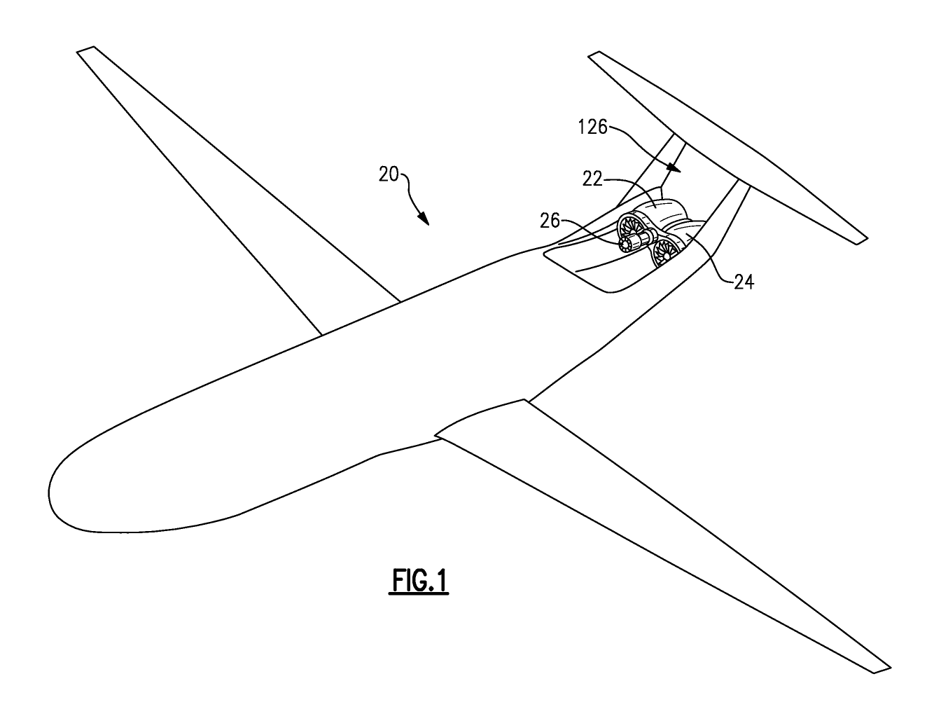

Air downstream of the turbine section 132 passes into a manifold 34, and will drive both propulsor units 22 and 24. A first propulsor unit 22 includes a fan rotor 30 received within a nacelle 51. The second propulsor unit 24 includes a fan rotor 28 received within a nacelle 53. The right hand side of FIG. 2 is towards the rear of the aircraft 20 (see FIG. 1). Thus, the gas generator 26 extends forwardly of the propulsor units 22 and 24. One can appreciate rotational axes of the fan rotors 28 and 30 and the core engine 26 are all offset from each other.

As shown in FIG. 3, the gas generator 26 is received within an opening 52 in the manifold 34, and there are flow distribution members 50 and 54 associated with the first 22 and second 24 propulsor units.

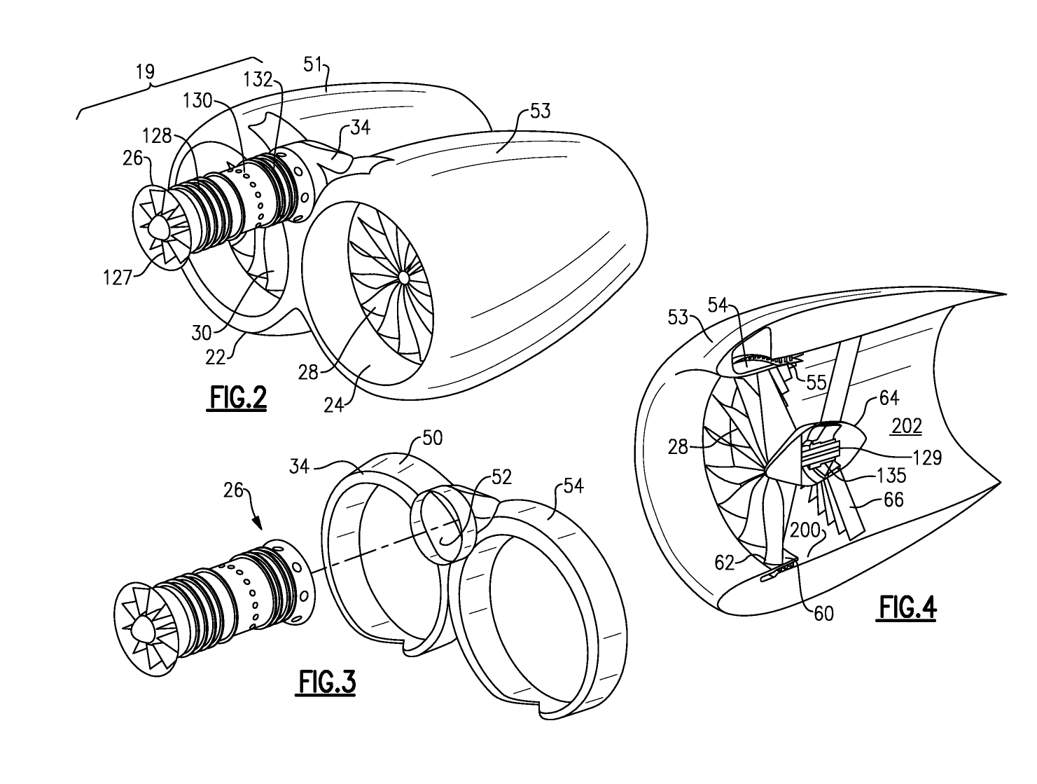

As shown in FIG. 4, the fan rotor 28 has a shaft 129 mounted within bearings 135, and the bearings are mounted within static vanes 66 which are otherwise secured within a nacelle 53. The vanes 66 are downstream of the rotor 28. Rotor 30 is mounted in a similar fashion.

The distribution unit 54 delivers high pressure air downstream of the turbine section 132 across a tip turbine 55. The tip turbine 55 is driven to rotate by this gas, and in turn drives a ring 60. Ring 60 is fixed to radially outer portion 62 of the blades in the fan rotor 28. Thus, the turbine 55 drives the fan rotor 28 to rotate. The gases downstream of the tip turbine 55 pass through an outlet 200 and communicate with an interior duct 202 within the nacelle 53, mixing with the air driven by rotor 28.

The single core engine or gas generator 26 is thus able to drive the twin propulsor units 22 and 24, and the overall arrangement fits within the package available on the aircraft 20.

A further feature that may be provided in the above disclosed gas turbine engine is disclosed in co-pending patent application entitled “Gas Turbine Engine Having Fan Rotor Driven by Turbine Exhaust, and With a Bypass,” Ser. No. ______ filed on even date herewith. Notably, this application relates to a bypass feature that provides additional application and power for a gas turbine engine on an aircraft.

Although an embodiment of this invention has been disclosed, a worker of ordinary skill in this art would recognize that certain modifications would come within the scope of this invention. For that reason, the following claims should be studied to determine the true scope and content of this invention.

1. A gas turbine engine comprising:
a core engine incorporating a core engine turbine; and
a manifold positioned downstream of said core engine turbine, said manifold delivering gas downstream of said core engine turbine into at least two nacelles, with each of said nacelles receiving a propulsor fan rotor, and each said fan rotor being fixed to rotate with a tip turbine mounted at a radially outer location of said propulsor fan rotor, with each said tip turbine being in the path of gases from said manifold.

2. The gas turbine engine as set forth in claim 1, wherein said core engine extends in a forward direction from said propulsor fan rotors.

3. The gas turbine engine as set forth in claim 1, wherein said core engine incorporates a compressor and a combustor.

4. The gas turbine engine as set forth in claim 1, wherein said propulsor fan rotors drive air through their respective nacelles as propulsion air.

5. The gas turbine engine as set forth in claim 4, wherein the gases passing over said tip turbines pass into said nacelle, and mix with said air driven by said propulsor fan rotors.

6. The gas turbine engine as set forth in claim 1, wherein each of said propulsor fan rotors has a shaft mounted within a bearing, said bearing fixed to said nacelle.

7. The gas turbine engine as set forth in claim 6, wherein a plurality of static vanes are positioned downstream relative to said fan rotor.

8. The gas turbine engine as set forth in claim 7, wherein said static vanes fix said bearing.

9. The gas turbine engine as set forth in claim 1, wherein each said propulsor fan rotor and said core engine turbine rotating about an axis, and said axes of rotation of said core engine turbine, and each of said fan rotors being offset relative to each other.

10. An aircraft comprising:
an aircraft body including a tail section, with a gas turbine engine mounted on said tail section, the gas turbine engine including a core engine incorporating a compressor, a combustor and a turbine, and a manifold positioned downstream of said core engine turbine, said manifold delivering gas downstream of said core engine turbine into at least two nacelles, with each of said nacelles receiving a propulsor fan rotor, and each said fan rotor being fixed to rotate with a tip turbine mounted at a radially outer location of said propulsor fan rotor, with each said tip turbine being in the path of gases from said manifold.

11. The aircraft as set forth in claim 10, wherein said core engine extends in a forward direction from said propulsor fan rotors.

12. The aircraft as set forth in claim 10, wherein said core engine incorporates a core fan rotor.

13. The aircraft as set forth in claim 12, wherein said propulsor fan rotors drive air through their respective nacelles as propulsion air.

14. The aircraft as set forth in claim 13, wherein the gases passing over said tip turbines pass into said nacelle, and mix with said air driven by said propulsor fan rotors.

15. The aircraft as set forth in claim 10, wherein each of said propulsor fan rotors has a shaft mounted within a bearing, said bearing fixed to said nacelle.

16. The aircraft as set forth in claim 15, wherein a plurality of static vanes are positioned downstream relative to said fan rotor.

17. The aircraft as set forth in claim 16, wherein said static vanes fix said bearing.

18. The aircraft as set forth in claim 10, wherein each said propulsor fan rotor and said core engine turbine rotating about an axis, and said axes of rotation of said core engine turbine, and each of said fan rotors being offset relative to each other.

19. A gas turbine engine comprising:
a core engine incorporating a core engine turbine rotating about an axis; and
a manifold positioned downstream of said core engine turbine, said manifold delivering gas downstream of said core engine turbine into at least two nacelles, with each of said nacelles receiving a propulsor fan rotor, and each said fan rotor being fixed to rotate with a fan rotor turbine, said fan rotor turbines being in the path of gas from said manifold, and said axes of rotation of said core engine turbine, and said fan rotors being offset relative to each other.

20. The gas turbine engine as set forth in claim 19, wherein said fan rotor turbines are tip turbines mounted at a radially outer location of each said fan rotor.
